(19) United States
(12) Patent Application Publication
(10) Pub. No.: US 2009/0237353 A1
(43) Pub. Date: Sep. 24, 2009

(54) Computer display capable of receiving wireless signals

(76) Inventor: James Chu, Walnut, CA (US)

Correspondence Address: BIRCH STEWART KOLASCH & BIRCH, PO BOX 747, FALLS CHURCH, VA, 22040-0747, US

(21) Appl. No.: 12/076,623

(22) Filed: Mar. 20, 2008

(51) Int. Cl. G09G 5/00

(52) U.S. Cl. 345/156

(57) ABSTRACT

A computer display capable of receiving wireless signals include a computer display provided with an antenna assembly for receiving wireless digital and analog A/V signals; and a female connector provided in the display for connecting the signals received via the antenna assembly to an external demodulating device, which is connected at a male connector thereof to the female connector in the display. The signals received by the antenna assembly is demodulated and converted by the external demodulating device, and transmitted to a personal computer via a transmission device for operation. The external demodulating device and the antenna assembly have a uniform specification for use with a computer display having the same specification to demodulate wireless signals.

### FIELD OF THE INVENTION

The present invention relates to a display, and more particularly to a computer display capable of receiving wireless signals.

### BACKGROUND OF THE INVENTION

It is generally known that a television (TV) set is required for watching TV programs. The TV set has an internal image receiving unit to receive and convert the received external audio/video (A/V) signals. In the future, almost all the TV programs and TV broadcasting A/V signals would be transmitted wirelessly. Meanwhile, with the advancements in scientific technologies, most people have a computer used at home on a long-term basis. Therefore, the display of the computer may be utilized to watch TV programs and save the space originally occupied by the conventional TV set. FIG. 1 shows a conventional way of using a computer display to watch TV programs. For this purpose, the conventional computer display 12 is connected to a TV box 10. The TV box 10 is connected to a power supply 14 to obtain the required power for operation, and includes an antenna 16 for receiving TV signals. The display 12 outputs the TV signals received and transmitted to the display 12 by the TV box 10. The display 12 also includes built-in or external loudspeakers to output sounds. A disadvantage of using the TV box 10 to receive TV signals is that the TV box must be connected to a power supply to be self-powered, and must have an antenna and a display panel for displaying receiving channels and operating status thereof.

The TV box also has the disadvantage of having a big volume to occupy additional space. The TV box must be externally connected to the computer display without the possibility of being directly combined with the computer display, such as a liquid crystal display (LCD), and would therefore occupy an independent space without the benefit of saving the valuable space.

It is therefore tried by the inventor to develop a computer display capable of receiving wireless signals to solve the problems existed in the conventional ways of watching TV programs on a computer display.

### SUMMARY OF THE INVENTION

A primary object of the present invention is to provide a computer display capable of receiving wireless signals that has an internal antenna assembly for receiving wireless digital signals, and the received signals are demodulated and converted by an external demodulating device, and then transmitted to a computer for operation, so that images could be played on the display. The conventional TV box externally connected to the display may therefore be omitted to effectively save the space that would be otherwise occupied by the TV box.

Another object of the present invention is to provide a computer display capable of receiving wireless signals that uses an external demodulating device connected thereto to demodulate wireless signals received by the display, and uses a computer host to operate the demodulated signals. It is not necessary to connect the external demodulating device to any external power supply to effectively save power energy.

A further object of the present invention is to provide a computer display capable of receiving wireless signals that includes an antenna assembly having the same specification as that of an external demodulating device connected to the display, so that the external demodulating device may be used with any computer display having the same specification to demodulate wireless signals received by the display.

To achieve the above and other objects, the computer display capable of receiving wireless signals according to the present invention includes a display provided with an antenna assembly for receiving wireless digital and analog A/V signals; and a female connector provided in the display for connecting the signals received via the antenna assembly to an external demodulating device connected at a male connector thereof to the female connector in the display. The signals received by the antenna assembly are demodulated and converted by the external demodulating device, and then transmitted to a computer host via a transmission device for operation. The external demodulating device and the antenna assembly have a uniform specification for use with any computer displays having the same specification to demodulate wireless signals received by the display.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional way of using a computer display to watch TV programs;

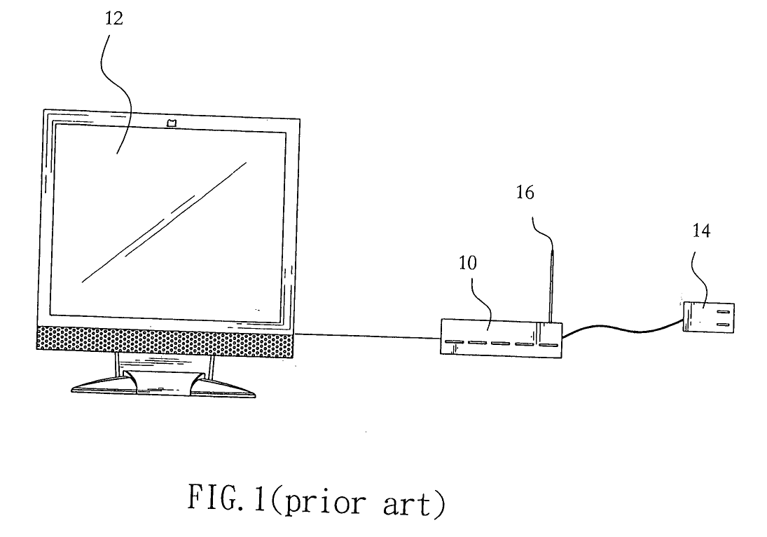

FIG. 2 shows a computer display capable of receiving wireless signals according to a first embodiment of the present invention; and

FIG. 3 shows a computer display capable of receiving wireless signals according to a second embodiment of the present invention.

### DETAILED DESCRIPTION OF THE PREFERRED EMBODIMENTS

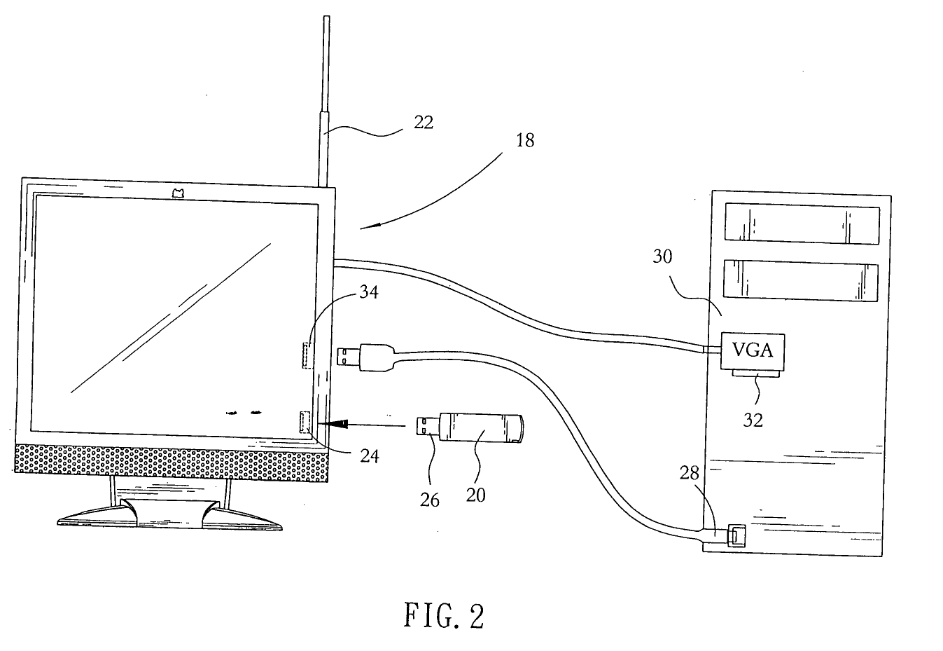

Please refer to FIG. 2 that shows a computer display capable of receiving wireless signals according to a first embodiment of the present invention. As shown, the display in the first embodiment of the present invention includes two major parts, namely, a computer display 18 and an external demodulating device 20. The display 18 is provided with an antenna assembly 22 for receiving wireless audio/video (A/V) signals. The antenna assembly 22 in the first embodiment is a telescopic antenna fixedly located outside the display 18 to receive wireless digital or analog A/V signals. The received signals are transmitted to a female connector 24 provided in the display 18. The external demodulating device 20 is provided at a front end with a male connector 26 for connecting to the female connector 24 in the display 18, so that the wireless signals received via the antenna assembly 22 may be transmitted via the connected female connector 24 and male connector 26 to the external demodulating device 20 for demodulation. The external demodulating device 20 demodulates the received wireless signals, and the demodulated signals are connected to a computer host 30 via a display connector 34 at an end and a transmission device 28 at the other end, so that the demodulated signals are operated by the computer host 30, and images are finally transmitted via a display card 32 in the computer host 30 to the display 18 for showing audio/visual pictures.

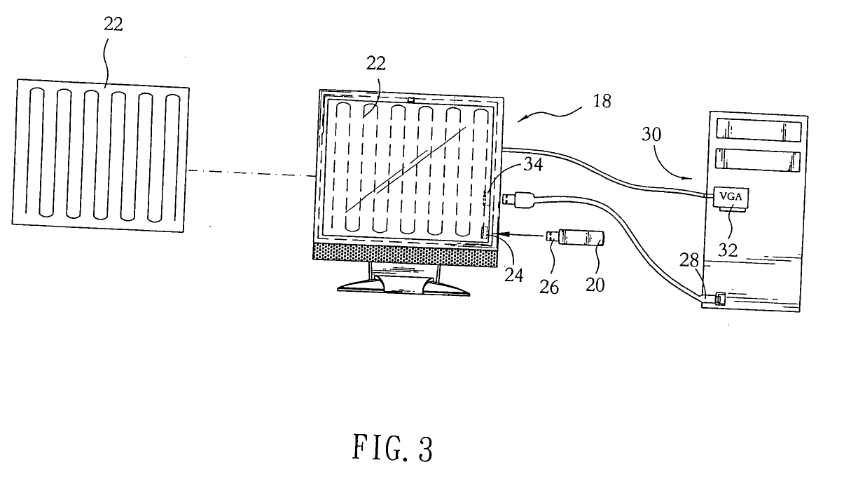

FIG. 3 shows a computer display capable of receiving wireless signals according to a second embodiment of the present invention. As shown, the second embodiment of the present invention also includes a computer display 18 and an external demodulating device 20. The display 18 of the second embodiment is internally provided with an antenna assembly 22, which is a built-in flexible antenna, for receiving wireless A/V signals. The built-in flexible antenna 22 may receive either wireless digital or analog A/V signals, and transmits the received signals to a female connector 24 provided in the display 18. The external demodulating device 20 is provided at a front end with a male connector 26 for connecting to the female connector 24 in the display 18, so that the wireless signals received via the antenna assembly 22 may be transmitted via the connected female connector 24 and male connector 26 to the external demodulating device 20 for demodulation. The external demodulating device 20 demodulates the received wireless signals, and the demodulated signals are connected to a computer host 30 via a display connector 34 at an end and a transmission device 28 at the other end, so that the demodulated signals are operated by the computer host 30, and images are finally transmitted via a display card 32 in the computer host 30 to the display 18 for showing audio/visual pictures.

The wireless signals received by the antenna assembly 22 may be DVB-T (Digital Video Broadcasting-Terrestrial) signals, or ATSC (Advanced Television Systems Committee) digital broadcasting signals. And, in the present invention, the male connector 26, the female connector 24, and the transmission device 28 are of a USB 2.0 high-speed serial connection interface or a 1394 high-speed serial connection interface.

As having been mentioned above, in the past, when a TV box is utilized to watch TV programs on a computer display, the TV box must be externally connected to the computer display, so that the TV box receives external wireless A/V signals, converts the received signals, and transmits the converted signals to the display for playing. The TV box must also be connected to an external power supply and could not be combined with the computer display, and would therefore occupy an independent space without the benefit of saving the valuable space. However, the computer display capable or receiving wireless A/V signals according to the present invention is applicable to general computer displays, and the internal antenna assembly and the external demodulating device have a uniform specification and may be used with any computer displays having a matching specification. With the internal antenna assembly 22 and the external signal demodulating device 20, wireless A/V signals may be received via the display 18 of the present invention and operated by a microprocessor of the computer 30, allowing a consumer to watch A/V programs on the display 18. The display 18 of the present invention does not occupy extra space and meets the new trends of displays.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A computer display capable of receiving wireless signals, comprising:
A computer display having an antenna assembly for receiving wireless audio and video (A/V) signals;
a female connector provided in said display; and
an external demodulating device adapted to connect to said female connector in said display;
said wireless A/V signals received by said antenna assembly being demodulated and converted by said external demodulating device, and then transmitted via a transmission device to a computer host for operation.

2. The computer display capable of receiving wireless signals as claimed in claim 1,.wherein said antenna assembly receives either wireless digital A/V signals or wireless analog A/V signals.

3. The computer display capable of receiving wireless signals as claimed in claim 1, wherein said antenna assembly is a telescopic antenna fixedly located outside said display.

4. The computer display capable of receiving wireless signals as claimed in claim 1, wherein said antenna assembly is a flexible antenna built in said display.

5. The computer display capable of receiving wireless signals as claimed in claim 1, wherein said female connector in said display is connected to said external demodulating device via a male connector provided on said external demodulating device.

6. The computer display capable of receiving wireless signals as claimed in claim 1, wherein said transmission device is of a USB 2.0 high-speed serial connection interface.

7. The computer display capable of receiving wireless signals as claimed in claim 1, wherein said transmission device is of a 1394 high-speed serial connection interface.

8. The computer display capable of receiving wireless signals as claimed in claim 1, wherein said display comprises a general computer display.

9. The computer display capable of receiving wireless signals as claimed in claim 1, wherein said antenna assembly has a uniform specification for mounting on a computer display having the same specification.

10. The computer display capable of receiving wireless signals as claimed in claim 5, wherein said female connector in said display and said male connector on said external demodulating device are of a USB 2.0 high-speed serial connection interface.

11. The computer display capable of receiving wireless signals as claimed in claim 5, wherein said female connector in said display and said male connector on said external demodulating device are of a 1394 high-speed serial connection interface.

12. The computer display capable of receiving wireless signals as claimed in claim 1, wherein said wireless signals are DVB-T signals.

13. The computer display capable of receiving wireless signals as claimed in claim 1, wherein said wireless signals are ATSC digital broadcasting signals.
